(19) United States
(12) Patent Application Publication
(10) Pub. No.: US 2015/0169592 A1
(43) Pub. Date: Jun. 18, 2015

(54) SYSTEM AND A METHOD FOR FACILITATING A PLATFORM FOR ONE OR MORE USERS TO COMPETE

(71) Applicant: HILARIO CASTILLO, Yonkers, NY (US)

(72) Inventor: HILARIO CASTILLO, Yonkers, NY (US)

(21) Appl. No.: 14/574,605

(22) Filed: Dec. 18, 2014

Related U.S. Application Data
(60) Provisional application No. 61/917,021, filed on Dec. 17, 2013.

(51) Int. Cl. G06F 17/30; H04L 29/08; H04L 29/06

(52) U.S. Cl. CPC G06F 17/30058; G06F 17/30595; H04L 65/403; H04L 67/06; H04L 67/1097; H04L 67/306

(57) ABSTRACT

A system for facilitating a platform for users to compete over a communication network. The system includes a camera for recording multimedia files, a database for storing multimedia files and instructions, and a processor. The processor includes an account module to register the users to access the database, a recording module records a video file of performance on the selected audio file in the beat module, a merging module merges the video file with audio file selected from the beat module to form a merge file, an upload module uploads the merged file on the database, an invitation module invites other registered users for a challenge on behalf of the first registered user, an acceptance module accepts the challenge on receiving a multimedia file from a second registered user, and a voting module receives individual votes from the other users, and further displays a winner based on the received votes.

### CROSS REFRENCE TO RELATED PATENT APPLICATION

The present invention claims priority of the provisional patent application No. 61917021, filed on Dec. 17, 2013; all of which are incorporated herein by reference in their entireties.

### BACKGROUND OF THE INVENTION

1. Field of the Invention

The present invention relates to a method and a system for facilitating a platform for one or more users to compete over the social media, and more particularly relates to a method and a system for uploading dynamic content in real-time and enabling comparisons of that content by others.

2. Description of Related Art

Online contests have been popular these days where the public selects a winner by giving like, share and comment over the social media network. Entertainment content is one of the unique sources to attract the online consumers. In many scenarios, user prefer to play games online or takes part in interesting competitions with other users who also have interests in the same field via a mobile and/or a web-based platform for the purpose of being social, competitive, and for added excitement.

There are online platforms available which allows people to promote their talent by uploading dynamic content. The platforms known to the people are YouTube, Selling Mixtapes, Facebook, contacting people high up in the Rap game. In these platforms further people may leave a comment, share and like the uploaded or published content. These platforms allow a user to participate in various contests published over the media and the winner may be one who gets the highest comments or vote or share. Such platforms do not support the users to create videos specific to their talents and also do not provide a battleground to participate in a battle among two users for showing talent.

Skill-based competitions have been popular these days, in which multiple users submit their performance related details such as short stories, photographs etc. the winner may be chosen on the basis of number of stars or rating given to the user. Such competitions require the proper organization and establishment, which leads to considerable amount of effort and time. There are lot of responsibilities which an organizer has to complete when organizing this kind of an event, like setting up the rules of the contest, publicizing the contest, selecting the way of choosing winner, receiving the entries, tally the results and notifying the winners.

In addition, it has been the contest organizer's responsibility to take care if there are any government regulations which apply to the contest, to also obtain any needed permissions from government authorities, and ensure that no applicable regulations are defiled by the contest. Hence, organizing such contests has typically become an expensive and slow process that is usually beyond the capabilities of an average citizen.

Recorded music available on media, such as on a CD, DVD allows a user to listen to particular performances such as songs and videos given by different users. In this case people can enjoy the available recorded performances rather than live performances. Dynamic media sharing such as videos, and music may be used for social discussions and gatherings. With the advancement of technology, users may upload videos and music files over social media network for competitive and cooperative purposes.

Therefore, there is a need of a system and a method for one or more users to compete in a media based virtual battleground. Further, the method and the system should allow the users to create video specific to talent incorporating with the media files to make it more interactive and invite people for the battleground.

### SUMMARY OF THE INVENTION

In accordance with the teachings of the present invention, a system for facilitating a platform for one or more users to interact over a communication network is provided.

An object of the present invention is to provide a system for facilitating a platform for one or more users to compete over a communication network. The system includes a camera for recording multimedia files, a database to store one or more pre-stored multimedia files and one or more instructions, and a processor. The pre-stored multimedia files selected from atleast one of: one or more audio files, one or more video files, and combination thereof. The processor coupled with the database to execute the one or more instructions. The one or more instructions include an account module, a beat module, a recording module, a merging module, an upload module, an invitation module, an acceptance module, and a voting module. The account module registers the users for accessing the database. The account module further allows the users to select atleast one category of one or more audio files. The beat module displays one or more audio files based on the selected category of the multimedia files in the account module.

The recording module records a video file of performance on the selected audio file in the beat module using the camera. The merging module merges the video file with an audio file selected from the beat module to form a merge file. The upload module uploads the merge file on the database. The invitation module invites one or more other registered users for a challenge on behalf of the first registered user. The acceptance module accepts the challenge on receiving a multimedia file from a second registered user. The voting module receives individual votes from the one or more users distinct from the first registered user and the second registered user, and further displays a winner based on the received votes.

The acceptance module further associates with the recording module to allow recording of a video file through the recording module using camera, further associate with the merging module to merge the video file with an audio file selected from the beat module to form another merged file, and further associate with the upload module to upload the another merged file on the database.

Another object of the present invention is to provide a purchase module for offering price information to the one or more registered users for purchasing the pre-stored audio files from the beat module. The purchase module further offering a price information to purchase the pre-stored audio files from the beat module by the one or more registered users on completing predetermined times of challenges.

Another object of the present invention is to provide a profile module for displaying profile information associated with the registered users.

Another object of the present invention is to provide a description module for detailing a challenge description to the one or more registered users.

Another object of the present invention is to provide a comment module for receiving comments on the competition in between two users.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 illustrates a block diagram of a system for facilitating a platform for one or more users to compete over a communication network in accordance with a preferred embodiment of the present invention;

FIG. 2 illustrates a flowchart of a method for facilitating a platform for one or more users to compete over a communication network with another preferred embodiment of the present invention;

FIG. 3A illustrates a screenshot showing, by way of an example, a UI for an account module in accordance with an embodiment of the present invention;

FIG. 3B illustrates a block diagram for displaying categories of one or more audio files in accordance with an exemplary embodiment of the present invention;

FIG. 3C illustrates a screenshot showing, by way of an example, a UI for a profile module in accordance with an embodiment of the present invention;

FIG. 4 illustrates a block diagram of a beat module for displaying the one or more audio files based on the category selection in accordance with an embodiment of the present invention;

FIG. 5 illustrates a screenshot showing, by way of an example, a UI for an upload module in accordance with an embodiment of the present invention;

FIG. 6 illustrates a screenshot showing, by way of an example, a UI for an invitation module in accordance with an embodiment of the present invention;

FIG. 7 illustrates a screenshot showing, by way of an example, a UI for an acceptance module in accordance with an embodiment of the present invention; and

FIG. 8 illustrates a screenshot showing, by way of an example, a UI for a voting module in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAIL DESCRIPTION OF DRAWINGS

While this technology is illustrated and described in a preferred embodiment, a system for facilitating a platform for one or more users to compete over a communication network may be produced in many different configurations, forms and computer languages. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

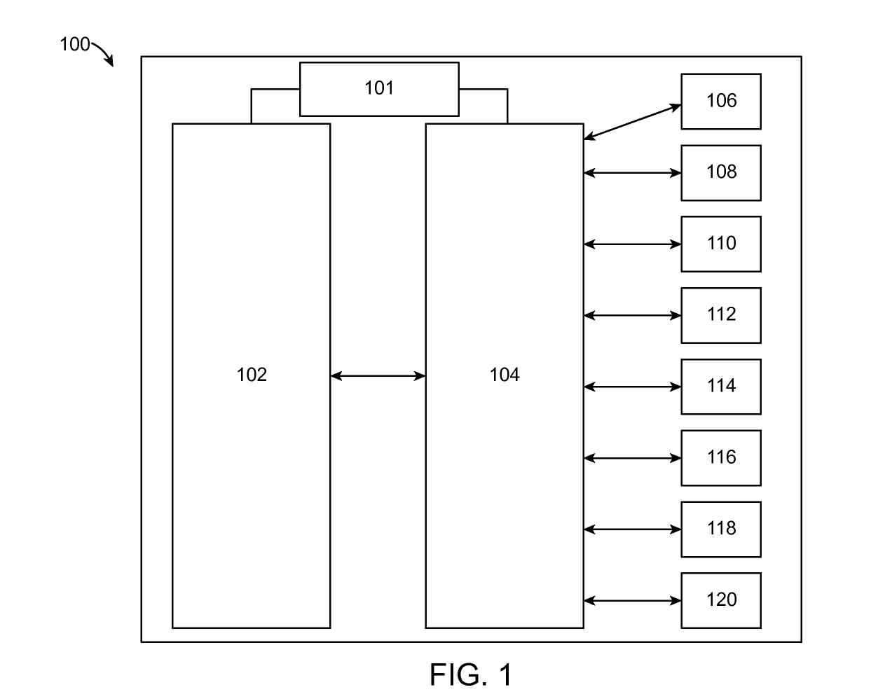

FIG. 1 illustrates a block diagram of a system 100 for facilitating a platform for one or more users to compete over a communication network. The system 100 includes a camera 101 for recording multimedia files, at least one database 102 for storing one or more pre-stored multimedia files and atleast one processor 104 coupled with at least one database 102 and the communication network. The processor 104 configured to execute one or more instructions stored in the at least one database 102. The processor 104 includes an account module 106, a beat module 108, a recording module 110, a merging module 112, an upload module 114, an invitation module 116, an acceptance module 118, and a voting module 120.

In a preferred embodiment of the present invention, the one or more multimedia files may be either an audio file, a video file, or a combination of the audio file and the video file. Example of the audio file includes but not limited to rap, music beats, song, a speech, recorded sound, audio clip or instrumental music. Example of the video file includes but not limited to video clip, a movie, an animation clip, a television program recording, or a video recording.

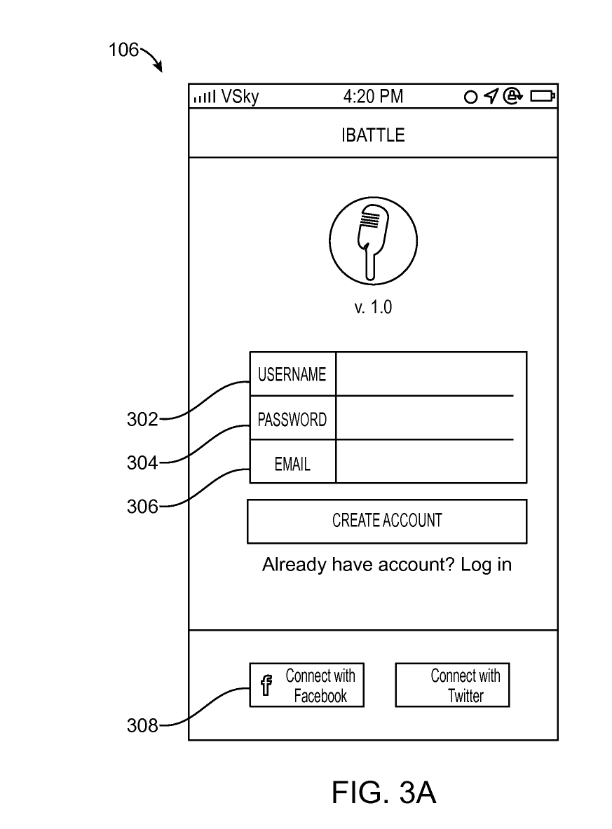

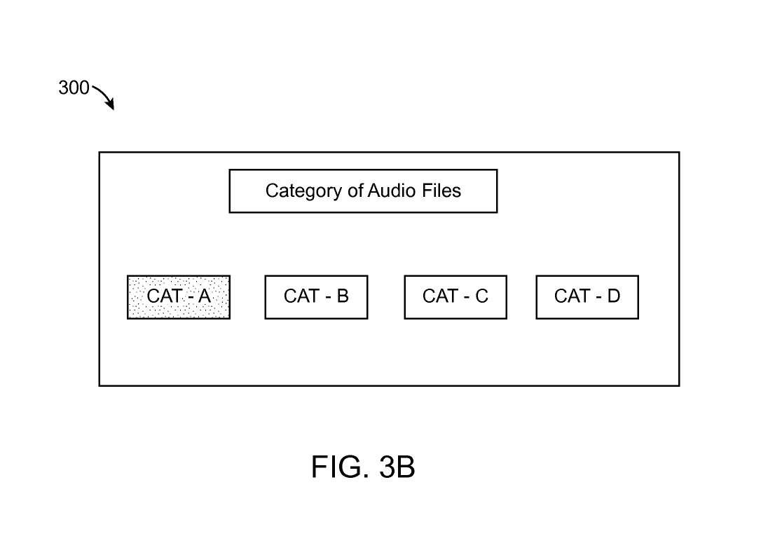

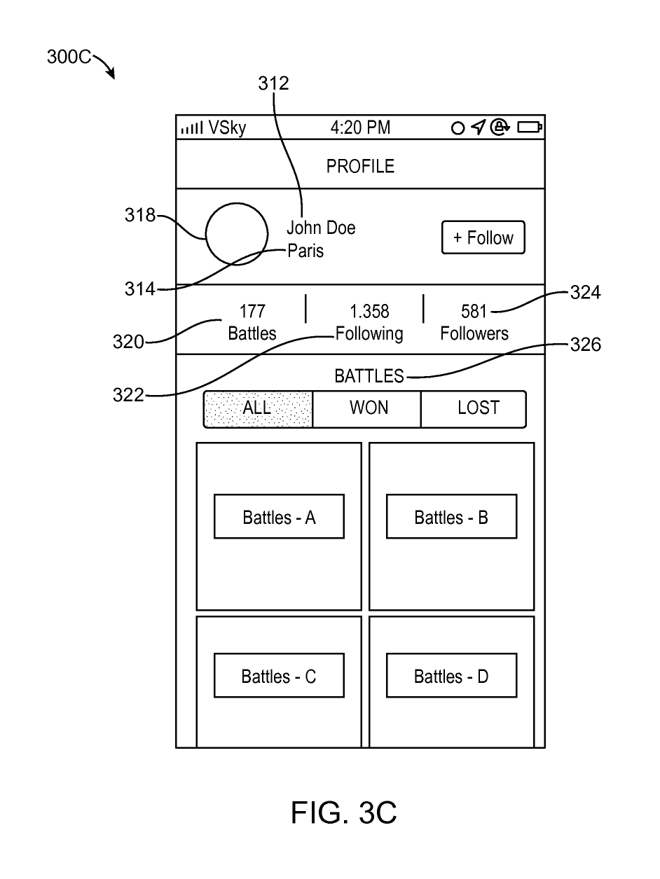

The account module 106 registers the users for accessing the database 102. Example of the database 102 includes but not limited to a central database, a cloud database or a system library. The account module 106 further allows the users to select at least one category displaying a playlist of multimedia files and furthermore displays the profile of the user through a profile module. The account module 106 is explained in detail in conjunction with FIG. 3a, FIG. 3b and FIG. 3c of the present invention.

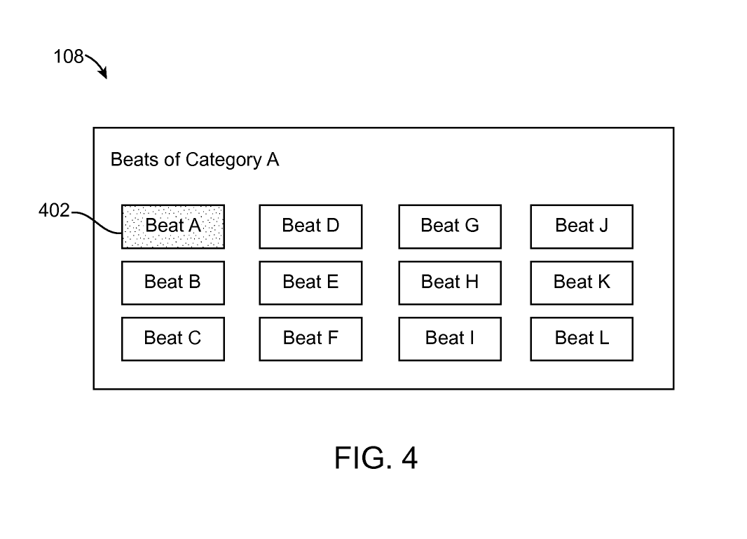

The beat module 108 displays one or more audio files based on the selected category of the multimedia files in the account module 106. The beat module 108 further allows the registered users to select atleast one audio file. The beat module 108 is explained in detail in conjunction with FIG. 4 of the present invention.

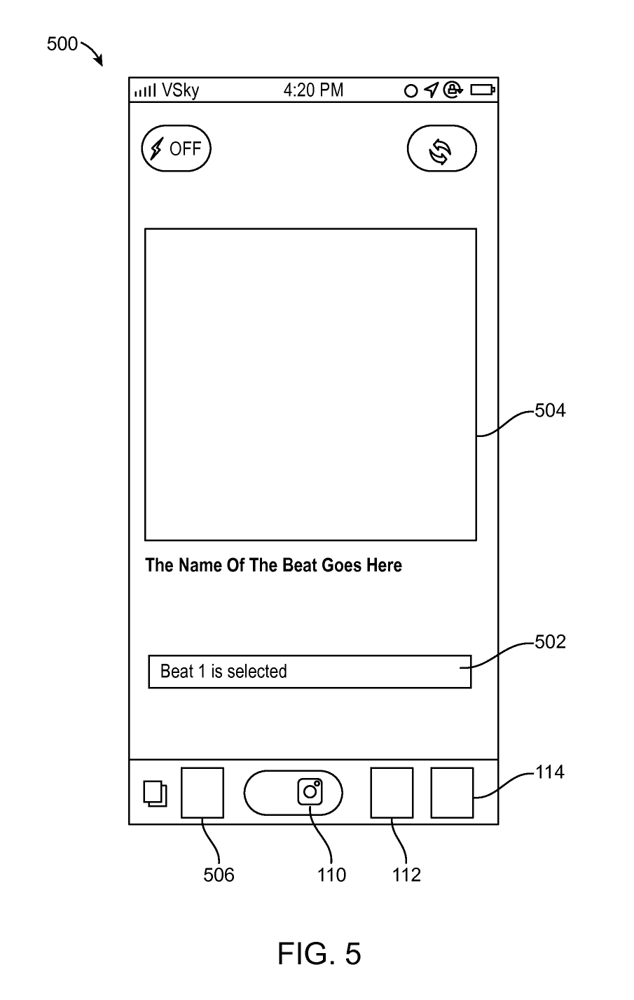

The recording module 110 allows a registered user to record video file of performance on the selected audio file in the beat module 108 using the camera 101. The merging module 112 allows the registered users to merge the recorded video files with atleast one audio file selected from the beat module 108. The recording module 110 and the merging module 112 are explained in detail in conjunction with FIG. 5 of the present invention.

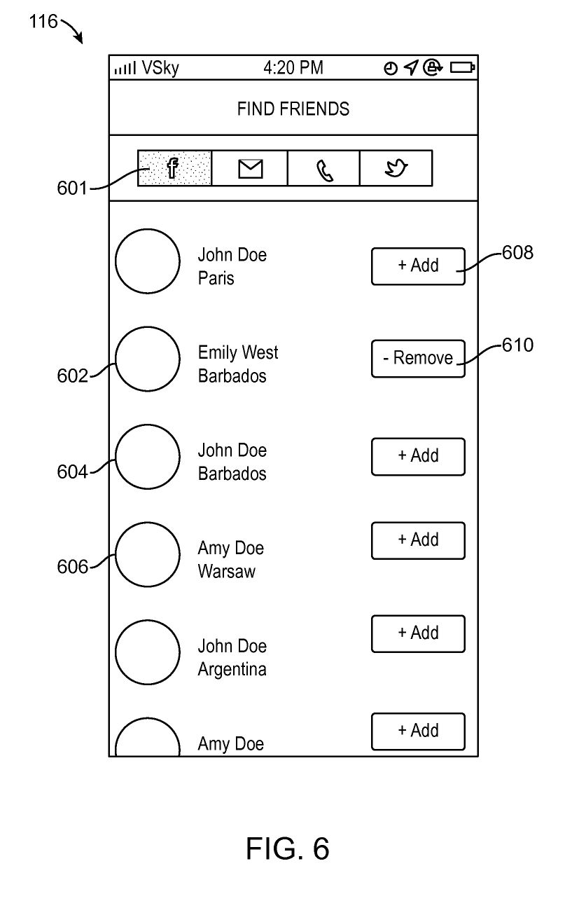

The upload module 114 uploads the merged file on the database. The upload module 114 is explained in detail in conjunction with FIG. 5 of the present invention. The invitation module 116 invites one or more other registered users for a challenge on behalf of the first registered user. The invitation module 116 is explained in detail in conjunction with FIG. 6 of the present invention.

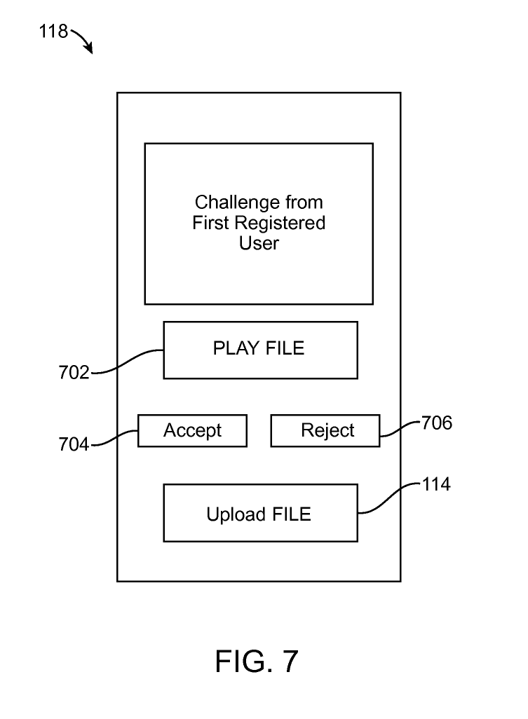

The acceptance module 118 accepts the challenge on receiving a multimedia file from a second registered user. The acceptance module 118 is explained in detail in conjunction with FIG. 7 of the present invention. In another preferred embodiment of the present invention, the acceptance module 118 allows the second user to update another merged file on the database through the acceptance module. The merged file is created by using the recording module 110, the merging module 112 and the upload module 114.

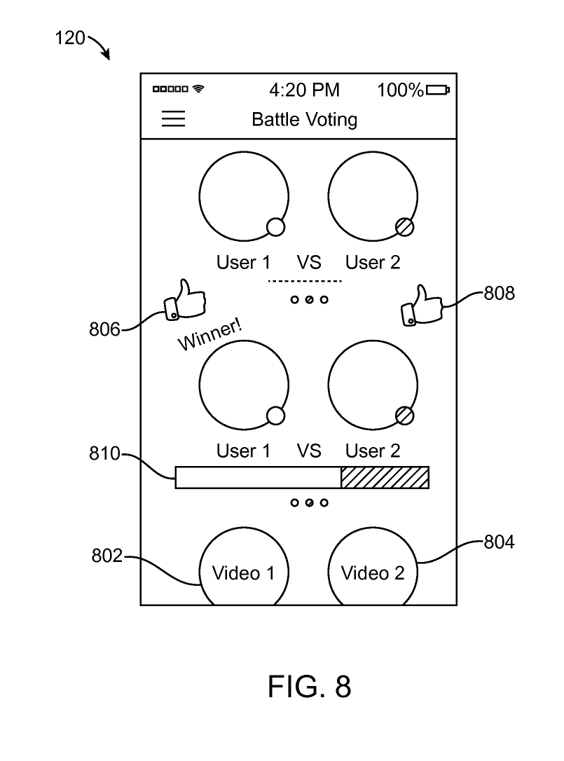

The voting module 120 receives individual votes from the one or more users distinct from the first registered user and the second registered user, and further displays a winner based on the received votes. In a preferred embodiment of the present invention, the user may like the video to cast the vote. However, it would be readily apparent to those skilled in the art that other methods of voting may be envisioned without deviating from the scope of the present invention. The voting module 120 is explained in detail in conjunction with FIG. 8 of the present invention.

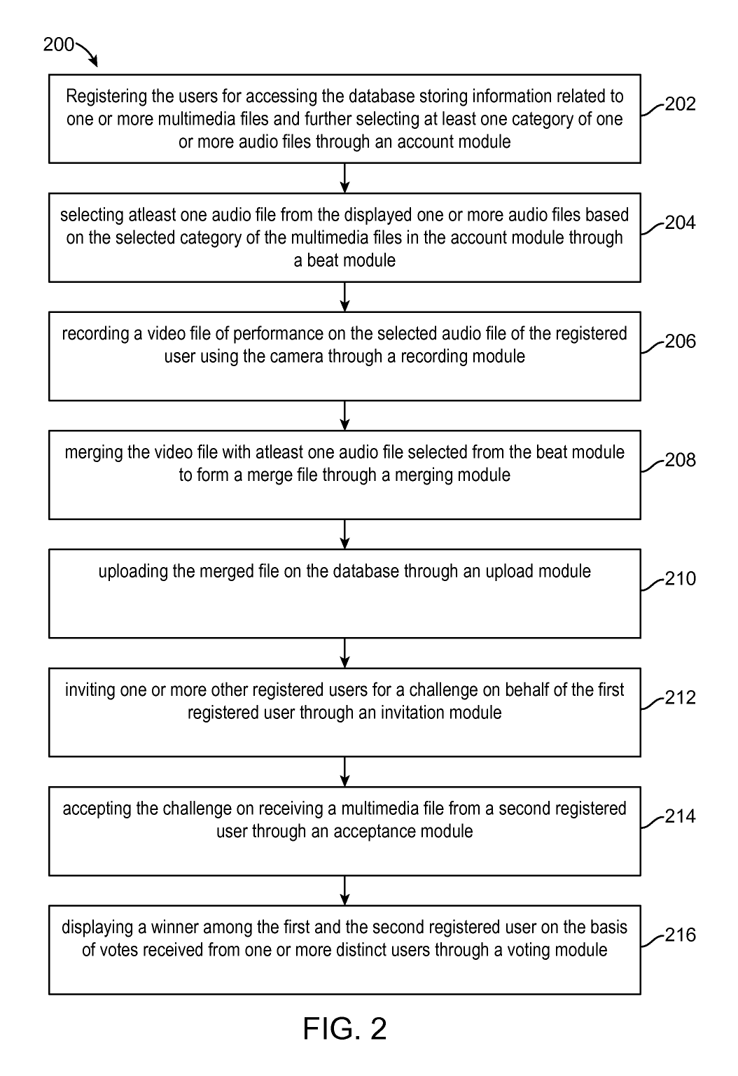

FIG. 2 illustrates a flowchart of a method 200 for facilitating a platform for one or more users to compete over a communication network. The method 200 initiates with a step 202 of registering the users for accessing the database storing information related to one or more multimedia files and further selecting at least one category displaying a playlist of multimedia files through an account module. The step 202 is explained in detail in conjunction with FIG. 1, FIG. 3a, FIG. 3b and FIG. 3c of the present invention.

The step 202 is followed by a step 204 of selecting atleast one audio file from the displayed one or more audio files based on the selected category of the multimedia files in the account module through a beat module. The step 204 is explained in detail in conjunction with FIG. 1 and FIG. 4 of the present invention.

The step 204 is then followed by a step 206 of recording a video file of performance on the selected audio file of the registered user using the camera through a recording module. The step 206 is explained in detail in conjunction with FIG. 1 and FIG. 5 of the present invention.

The step 206 is then followed by a step 208 of merging the video file with atleast one audio file selected from the beat module to form a merge file through a merging module. The step 208 is explained in detail in conjunction with FIG. 1 and FIG. 5 of the present invention.

The step 208 is then followed by a step 210 of uploading the merged file on the database through an upload module. The step 210 is explained in detail in conjunction with FIG. 1 and FIG. 5 of the present invention. The step 210 is then followed by a step 212 of inviting one or more other registered users for a challenge on behalf of the first registered user through an invitation module. The step 212 is explained in detail in conjunction with FIG. 1 and FIG. 6 of the present invention.

The step 212 is then followed by a step 214 of accepting the challenge on receiving a multimedia file from a second registered user through an acceptance module. The step 214 is explained in detail in conjunction with FIG. 7 of the present invention. The step 214 is then followed by a step 216 of displaying a winner among the first and the second registered user on the basis of votes received from one or more distinct users through a voting module. The step 216 is explained in detail in conjunction with FIG. 9 of the present invention.

FIG. 3A illustrates a screenshot showing, by way of an example, a UI for the account module 106 for registering a user on the database in accordance with an embodiment of the present invention. The account module 106 enables the user to perform the registration by providing details such as a username 302, a password 304, and already registered electronic mail information 306.

An account is created for the user based on the details provided by the user. In another preferred embodiment of the present invention, the user may further register in the database through a social networking site such as Facebook 308, twitter 310 and google+. It would be readily apparent to those skilled in the art that other information may also be required to register on the database without deviating from the scope of the present invention. The examples for registered users includes but not limited to a beat maker, rapper, singer, comedians, artists, athletes, DJ's or music lover.

FIG. 3B illustrates a block diagram 300 for displaying categories of one or more audio files in an exemplary embodiment of the present invention. The user may select atleast one category to receive list of available beats in the selected category. In a preferred embodiment of the present invention, the database displays categories of audio files such as CAT-A, CAT-B, CAT-C, and CAT-D. Example of categories include but not limited to genre, artists, rock beats, metal beats, pop beats, rap beats etc. In a preferred embodiment of the present invention, the user selects CAT-A, and the list of beats under category CAT-A is displayed and explained in conjunction with FIG. 4 of the present invention.

FIG. 3C illustrates a screenshot showing, by way of an example, a UI of profile module 300c of a registered user on the database in accordance with an exemplary embodiment of the present invention. The profile module 300c displays the information of the user such as name 312, location 314, logo 318, rankings 320, following 322, followers 324, and battle details 326.

In an exemplary embodiment as shown in FIG. 3c, the name 312 is John Doe, the location 314 is Parls, the rankings 320 is 177, the following 322 is 1,358, the followers 324 is 581. The battle details 326 include details such as All battles, Won Battles and Lost Battles of the John Doe.

FIG. 4 illustrates a block diagram of the beat module 108 for displaying the one or more audio files based on the category selection of the multimedia files by the user in the account module in accordance with an embodiment of the present invention. With reference to FIG. 3B of the present invention, the user selects Category A and thus the audio files associated with the category A is displayed to the user.

The user then selects an audio file, such as Beat A 402 from the various audio files displayed. Examples of other audio files include but not limited to Beat B, Beat C, Beat D etc. In another preferred embodiment of the present invention, the user may select the audio files on hearing or by the name of the audio file. In a preferred embodiment of the present invention, the beat producers upload the beats to the database under the beat module 108. This allows the users to avail all the beats to participate in contest with other registered users.

FIG. 5 illustrates a screenshot showing, by way of an example, a UI 500 for the recording module 110, the merging module 112, and the upload module 114 in accordance with an embodiment of the present invention. The recording module 110 records a video file of performance on the selected audio file 502. The recording module 110 is associated with the camera to record video of the first registered user e.g. rapper, music lover or performer recording a first video file.

The UI 500 further displays a screen 504 to display the performance of the user while using the camera. On completing the performance the user may view the recording of the performance by clicking on play button 506. In a preferred embodiment of the present invention, the front camera is associated with the recording module 110. However, it would be readily apparent to those skilled in the art that back camera may also be associated with the recording module 110 to record the video performance of the user.

The merging module 112 allows the user to merge the audio file 502 and the video performance recorded via using camera. The merged file is then stored in the database. The upload module 114 then uploads the merged file on the database created from the merging module 112.

FIG. 6 illustrates a screenshot showing, by way of an example, a UI for invitation module 116 invites one or more other registered users from the database for a challenge on behalf of the first registered user in accordance with an embodiment of the present invention. The registered user may invite other registered users by clicking on add button.

In a preferred embodiment of the present invention, the registered users would be able to invite other users from other platforms including but not limited to social media platform, email, phone etc. For exemplary purposes as shown in FIG. 6, the user may invite other users such as Emily West 602 from Barbados, John Doe 604 from Barbados, Amy Doe 606 Warsaw by clicking add button 608 or removing other users by remove button 610 from the Facebook account.

In a preferred embodiment of the present invention, the invitation module 116 sends a closed challenge request to invite the second registered users. The closed challenge request refers to the personal meeting request in between two registered users. The invitation module 116 further sends an open challenge request through one or more social networking sites e.g. Facebook, twitter to invite the other users for head-to-head challenge in another preferred embodiment of the present invention. In case of the open challenge request, more than one registered users may accept the challenge request of the first registered user. For an example, the rapper 2, and rapper 3 both may accept the challenge received from the rapper 1.

FIG. 7 illustrates a screenshot showing, by way of an example, a UI of acceptance module 118 in accordance with an embodiment of the present invention. The acceptance module 118 allows the second registered user to accept the challenge from the first registered user. In another preferred embodiment of the present invention, the second user may further play file to view the multimedia file set, as challenged by the first user. Thus, on viewing the file the second user accepts the challenge of the first user.

For exemplary purposes, the UI includes play file button 702 to play the multimedia file. The second registered user then responds to the challenge either by accepting or rejecting by clicking on the accept button 704 or the reject button 706 respectively. The second registered user uploads the file as acceptance to the challenge through the upload module 114. In another preferred embodiment of the present invention, the upload module 114 further allows the user to upload the media file via e-mail, airdrop, Facebook, twitter, YouTube, and metacafe.

In another preferred embodiment of the present invention, the user may upload the file created by using the recording module and the merging module. The recording module and the merging module is explained in detail in conjunction with FIG. 1 and FIG. 5 of the present invention.

FIG. 8 illustrates a screenshot showing, by way of an example, a UI of voting module 120 for receiving individual votes from the one or more users distinct from the first registered user and the second registered user in accordance with an embodiment of the present invention. In a preferred embodiment the other registered users may view both the videos by clicking video 1 802, video 2 804.

The user may cast their vote by clicking either first like button 806 or second like button 808 corresponding to user 1 and user 2 respectively. In a preferred embodiment the voting module 120 displays the ratio bar graph 810 to show the winner among the two users. However, it would be readily apparent to those skilled in the art that various methods of displaying the winner may be envisioned without deviation from the scope of the present invention.

In another preferred embodiment of the present invention, system includes a description module for detailing a challenge description to the one or more registered users in accordance with another preferred embodiment of the present invention. The description module provides a detail of the uploaded multimedia files through a text module. The text module provides a user with the detail of the multimedia files such as profile of the uploader, type of the music, type of the accent used, or lyrics.

The description module enables the users to view the video uploaded by a rapper. The description module further displays the total count of the view. Further the description module displays the total count of likes or favorites given by the users. Furthermore the description module displays the total number of comments given by the various users.

In another embodiment of the present invention, the purchase module (not shown in Figures) offers price information to the one or more registered users to continue the multimedia files access after completing the free trial of media file access. For an example, each day the registered user may have 5 challenges, after the 5th challenge, if they want to continue the user has to purchase extra challenges at a dollar each. In addition the user may further have an option to buy one or more challenges in bulk.

In another embodiment of the present invention, a notification module (not shown in Figures) notifies the updated activity to one or more registered user. Further the registered users may get the push notifications related to the battles. For example, the notifications related to battles may be the challenge request, comments given by the other registered users on the battle and the likes given by the other registered users on the battle.

In preferred embodiment of the invention, the comment module (not shown in Figures) allows the registered users to write comments after watching the battle videos. The other users may give response on the videos by writing appreciating comments. In another embodiment of the present invention, the settings module provide the setting facilities associated with the application.

The settings module includes the profile settings, social accounts settings and notifications settings. Further the profile settings include edit account tab, battle points tab, and log out tab. The edit account tab enables the registered user to edit the account details. The battle points tab allows the registered users to see the total number of battle points. The social accounts settings includes Facebook tab and twitter tab and notifications settings include challenges tab, friend request tab and comments tab. The user profile tab displays the profile information of the application user. The notification settings tab provides the settings corresponding to the sound of notifications. The notifications include text messages, voice messages and video messages.

In an example, the merging module 112 enables the registered user to merge the first recorded video file with the one audio file such as beat selected by the user e.g. the first video file may be the video clip of rap captured by the first registered user e.g. rapper. The video clip of rap 1 is merged with a first audio file e.g. audio beat selected from a playlist of the audio beats composed by the beat maker.

In a preferred embodiment of the present invention, the system 100 may automatically provide a beat or a selection of various beats for rappers to use to battle based on their profile. The rappers may be asked to mention about their favorite genre, song, or artists. Based on the selection of their favorite genre, song or artist, the system 100 may automatically provide beats that match this description from the beats submitted by the producers or beat makers.

Further the producers or beat makers may be asked to tag their corresponding beats or music with certain artists or songs that are similar to that beat. This similarity may allow the system 100 to provide the rappers similar beats to battle with from the beats the producers have submitted. For example, a rapper who wants to battle may provide in his profile that he likes rap music, his favorite artist is Jay Z, nas, biggie smalls etc. and favorite songs could be x, y, z song. The producer will be asked to tag their beat submission with a different number of artist or songs that are similar to that beat. When the rapper goes to the battle screen they will have a number of beats to select that match his profile so they can battle.

In another preferred embodiment of the present invention, the present system automatically suggests battles for users based on the best winners. Each user is allotted in a group based on the winning percentage. For example, User A has won 100 battles and lost 5 battles, and thus is in gold group. Thus, the system automatically suggests battle with other users in the same gold group. It would be readily apparent to those skilled in the art that various names and winning percentage for the group segregation may be envisioned without deviating from the scope of the present invention.

Thus the present system and method provide one or more users to compete in a media based virtual battleground. Further, the present system and the method also allowing the users to create video specific to talent incorporating with the media files to make it more interactive and inviting people for the battleground.

The foregoing discussion discloses and describes merely exemplary embodiments of the present invention. One skilled in the art will readily recognize from such discussion and from the accompanying drawings that various changes, modifications and variations may be made therein without departing from the spirit and scope of the invention. Therefore, it is intended that the invention not be limited to the particular embodiment disclosed, but that the invention will include all embodiments falling within the scope of the appended claims.

1. A system for facilitating a platform for one or more users to compete over a communication network, the system comprising:
a camera for recording multimedia files;
a database to store one or more pre-stored multimedia files and one or more instructions, wherein the pre-stored multimedia files selected from atleast one of: one or more audio files, one or more video files, and combination thereof; and
a processor coupled with the database to execute the one or more instructions, the one or more instructions comprising:
an account module registers the users for accessing the database, the account module further allows the users to select atleast one category of one or more audio files;
a beat module displays one or more audio files based on the selected category of the multimedia files in the account module, wherein the registered user selects atleast one audio file;
a recording module records a video file of performance on the selected audio file in the beat module using the camera;
a merging module merges the video file with atleast one audio file selected from the beat module to form a merge file;
an upload module uploads the merged file on the database;
an invitation module invites one or more other registered users for a challenge on behalf of the first registered user;
an acceptance module accepts the challenge on receiving a multimedia file from a second registered user; and
a voting module receives individual votes from the one or more users distinct from the first registered user and the second registered user, and further displays a winner based on the received votes.

2. The system according to claim 1, wherein the acceptance module further associates with the recording module to allow recording of a video file through the recording module using camera, further associate with the merging module to merge of the video file with atleast one audio file selected from the beat module to form another merge file, and further associate with the upload module to upload the another merged file on the database.

3. The system according to claim 1 further comprising a purchase module for offering price information to the one or more registered users for purchasing the pre-stored audio files from the beat module.

4. The system according to claim 3, wherein the purchase module further offering a price information to purchase the pre-stored audio files from the beat module by the one or more registered users on completing predetermined times of challenges.

5. The system according to claim 1 further comprising a profile module for displaying profile information associated with the registered users.

6. The system according to claim 1 further comprising a description module for detailing a challenge description to the one or more registered users.

7. The system according to claim 1 further comprising a comment module for receiving comments on the competition in between atleast two users.

8. A method for facilitating a platform for one or more users to compete over a communication network, the method comprising the steps of:
registering the users for accessing the database storing information related to one or more multimedia files and further selecting at least one category displaying a playlist of multimedia files through a account module;
selecting atleast one audio file from the displayed one or more audio files based on the selected category of the multimedia files in the account module through a beat module;
recording a video file of performance on the selected audio file of the registered user using the camera through a recording module;
merging the video file with atleast one audio file selected from the beat module to form a merge file through a merging module;
uploading the merge file on the database through an upload module;
inviting one or more other registered users for a challenge on behalf of the first registered user through an invitation module;
accepting the challenge on receiving a multimedia file from a second registered user through an acceptance module; and
displaying a winner among the first and the second registered user on the basis of votes received from one or more distinct users through a voting module.

9. The method according to claim 8 further including the steps of:
recording a video file by the second register user using the camera through the recording module;
merges the video file with at least one audio file selected from the beat module to form another merge file through the merging module; and
uploading the another merge on the database through the upload module.

10. The method according to claim 8 further comprising the step of offering price information to the one or more registered users for purchasing the pre-stored audio files from the beat module through a purchase module.

11. The method according to claim 10 further comprising the step of offering price information to purchase the pre-stored audio files from the beat module by the one or more registered users on completing predetermined times of challenges through the purchase module.

12. The method according to claim 8 further comprising the step of displaying profile information associated with the registered users through a profile module.

13. The method according to claim 8 further comprising the step of detailing a challenge description to the one or more registered users.

14. The method according to claim 8 further comprising the step of receiving comments on the competition in between atleast two registered users.

15. A non-transitory computer readable medium storing a program causing a computer to execute the set of instructions, the set of instructions comprising:
registering the users for accessing the database storing information related to one or more multimedia files and further selecting at least one category displaying a playlist of multimedia files through a account module;
selecting atleast one audio file from the displayed one or more audio files based on the selected category of the multimedia files in the account module through a beat module;
recording a video file of performance on the selected audio file of the registered user using the camera through a recording module;
merging the video file with atleast one audio file selected from the beat module to form a merge file through a merging module;
uploading the merge file on the database through an upload module;
inviting one or more other registered users for a challenge on behalf of the first registered user through the invitation module;
accepting the challenge on receiving a multimedia file from a second registered user through a acceptance module; and
displaying a winner among the first and the second registered user on the basis of votes received from one or more distinct users through a voting module.

16. The non-transitory computer readable medium according to claim 15, wherein the set of instructions further comprising:
recording a video file by the second register user using the camera through the recording module;
merges the video file with at least one audio file selected from the beat module to form another merge file through the merging module; and
uploading the another merge on the database through the upload module.

17. The non-transitory computer readable medium according to claim 15, wherein the set of instructions further comprising offering price information to the one or more registered users for purchasing the pre-stored audio files from the beat module through a purchase module

18. The non-transitory computer readable medium according to claim 15, wherein the set of instructions further comprising displaying profile information associated with the registered users through a profile module.

19. The non-transitory computer readable medium according to claim 15, wherein the set of instructions further comprising detailing a challenge description to the one or more registered users.

20. The non-transitory computer readable medium according to claim 15, wherein the set of instructions further comprising receiving comments on the competition in between atleast two registered users.
